(19) United States
(12) Patent Application Publication
(10) Pub. No.: US 2004/0019529 A1
(43) Pub. Date: Jan. 29, 2004

(54) Publicly accessible deferred purchasing system

(75) Inventors: Scott J. Broussard, Cedar Park, TX (US); Joseph Herbert Mcintyre, Austin, TX (US); Eduardo N. Spring, Round Rock, TX (US)

Correspondence Address: Bigger's OHANIAN, PLLC, 5 SCARLET RIDGE, AUSTIN, TX, 78737, US

(73) Assignee: INTERNATIONAL BUSINESS MACHINES CORPORATION, ARMONK, NY (US)

(21) Appl. No.: 10/205,105

(22) Filed: Jul. 25, 2002

(51) Int. Cl. G06F 17/60

(52) U.S. Cl. 705/26

(57) ABSTRACT

Publicly accessible purchasing systems including receiving from a purchaser in a publicly accessible purchasing system, a deferred purchase request (“DPR”), in which the DPR includes a DPR identification, a purchaser identification, an item description of an item to be purchased, an identification of a vendor, and an issue date when a purchase order is to be issued to the vendor. Embodiments also include creating the purchase order in dependence upon the DPR, and issuing the purchase order to the vendor on the issue date.

### BACKGROUND OF THF INVENTION

1. Field of the Invention

The field of the invention is data processing, or, more specifically, methods, systems, and products for publicly accessible deferred purchasing systems.

2. Description of Related Art

In the current art of on-line purchasing, there is no useful way to enter a delayed purchase request for a purchase order to be issued to a vendor at a later time. In current art, on-line purchasers enter current purchase orders directed to known vendors. Often, however, purchasers have gift or supply purchasing obligations, or other purchasing obligations, occurring at predictable times in the future, for which it would be convenient to plan now, for example, as an aid to memory or as part of a budgeted business plan. Or in some cases, regardless of memory or plans, a purchaser has time to work on-line now but knows that she will not have much time later when a purchase is needed.

That is, the subject of the present disclosure is delayed purchasing. More specifically, our subject is knowing today that a purchaser wishes to effect a purchase at some time in the future and making available to the purchaser a publicly-accessible system for entering deferred purchase orders having issue dates that result in the issuance of purchase orders on the issue dates. The advantage of such a public delayed purchasing system is that delayed purchase orders can be created as planning mechanisms days, week, or months in advance of the actual issuance date, for convenience, for planning, as aids to memory, for birthdays, anniversaries, holiday gifts and greetings, and so on. The benefits are for personal use and for business use, as in the case of advance entries of deferred purchase orders for estimated quantities of office supplies, so that even tiny businesses can have the benefits of ‘just-in-time’ controls of needed supplies, with no need to invest heavily in the infrastructure to effect such controls.

A publicly available delayed purchasing system would be even more beneficial if it were accessible by a variety of network-oriented interfaces, including, for example, personal computers communicating via the Internet, ordinary telephones, hand-held wireless internet-enabled special purpose devices, internet-enabled personal digital assistants, mobile phones, internet-enabled cell phones, and so on. Such publicly accessible delayed purchasing systems do not exist, although it would be advantageous if they did.

### SUMMARY OF THE INVENTION

Delayed purchasing systems according to exemplary embodiments of the present invention typically include receiving from a purchaser in a publicly accessible purchasing system, a deferred purchase request (“DPR”). A DPR typically includes an item description of an item to be purchased and an issue date when a purchase order is to be issued to a vendor. Such delayed purchasing systems typically include creating the purchase order in dependence upon the DPR and issuing the purchase order to the vendor on the issue date. DPRs may include vendor descriptions.

Exemplary embodiments of the invention may include sending a notification to the purchaser prior to the issue date, the notification comprising the issue date and the item description. In such embodiments, the notification may include a request for a pre-issue date confirmation response by the purchaser. Such embodiments typically include terminating the DPR, when no confirming response is received

In delayed purchasing systems according to exemplary embodiments of the invention, receiving a DPR may include receiving a plurality of DPR for the same item to be purchased from the same vendor. Such embodiments may send a notification to the vendor, the notification including the issue dates, the item description and the identification of the DPRs in the plurality.

In additional exemplary embodiments, DPRs includes payment information. Such embodiments typically include verifying the payment information prior to the issue date. Such embodiments typically include terminating the DPR if the payment information verification is unsatisfactory. Such embodiments may send a request for supplemental payment information to the purchaser. Such embodiments typically include terminating the DPR when no verifiable supplemental payment information is received.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION ON THE DRAWINGS

FIG. 1 is a general process flow diagram illustrating a typical example embodiment of the present invention.

FIG. 2 is a general process flow diagram illustrating a typical example embodiment of the present invention.

FIG. 3 depicts an example of an embodiment of a table for deferred purchase requests.

FIG. 4 is a process flow diagram illustrating a purchaser notification aspect of typical example embodiments of the present invention.

FIG. 5 is a process flow diagram illustrating a vendor notification aspect of typical example embodiments of the present invention.

FIG. 6 is a process flow diagram illustrating a payment information verification aspect of typical example embodiments of the present invention.

### DETAILED DESCRIPTION OF EXEMPLARY EMBODIMENTS

### Introduction

The present invention is described to a large extent in this specification in terms of methods for publicly accessible deferred purchasing systems. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executed on computer hardware, nevertheless, alternative embodiments implemented as firmware or as hardware are well within the scope of the present invention.

### Definitions

In this specification, the term “Field” is used to refer to data elements, that is, to to individual elements of digital data. Aggregates of fields are referred to as “records.” Aggregates of records are referred to as “tables.”

Data Definition Language (“DDL”) is often used to create data schema or record structures for tables. In this specification, scripts operable for creating record structures in tables are referred to as ‘DDL scripts.’

A “SLEE server” is a server operating portable telecommunication services and application frameworks in a JAIN SLEE compliant execution environment. “JAIN” refers to the JAVA API for Integrated Networks. SLEE servers in typical embodiments of the present invention are implemented in JAVA using the JTAPI, the Java Telephony API. “JAIN SLEE,” or the JAIN Service Logic Execution Environment, an element of Sun Microsystems' industry-oriented de facto standard JAIN initiative, is a set of interfaces and standards for telecommunications and Internet operations within carrier grade telecommunications networks and Internet networks. JAIN-compliant telecommunications services are tested and deployed in the JAIN Service Logic Execution Environment.

“Parlay” refers to the Open Service Access (“OSA”) Application Programming Interface (“API”) of the multi-vendor industry consortium known as the “Parlay Group.” The OSA API is a technology-independent API that enables applications and technology solutions to operate across multiple networking platform environments.

“Java” is an industry-standard programming language.

“Wireless Application Protocol (“WAP”) is a specification for users with handheld wireless devices to access information, including information on the internet and other applications utilizing the Internet Protocol (IP). The devices include mobile phones, pagers, two-way radios, hand-held computers, and the like.

### Detailed Description

In this disclosure we present exemplary embodiments of a publicly accessible deferred purchasing system that provides the public an opportunity to place an order for goods or services and indicate a date in the future on which a purchase order will issue to a vendor for the goods or services. In typical embodiments of the present invention, purchasers have accounts with a provider and have secure access through logon identifications and security codes. The provider in such embodiments is typically a telephone service provider or an internet service provider.

Embodiments of the invention typically include a user-interface that prompts the purchaser for appropriate information resulting in the creation of a deferred purchasing request, referred to herein as a “DPR.” A purchase order is created based on the DPR and is issued on an “issue date” selected by the purchaser.

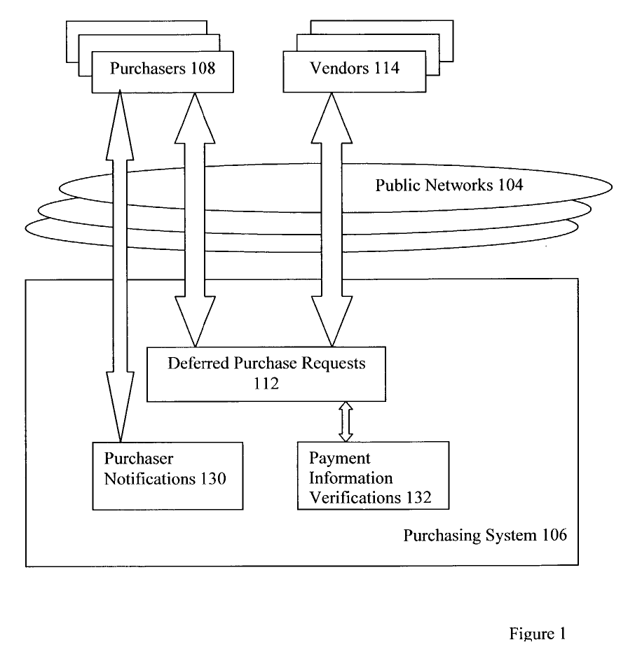

FIG. 1 is a block diagram depicting the overall structure of a deferred purchasing system according to an exemplary embodiment of the present invention. The deferred purchasing according to FIG. 1 includes purchasers (108) who enter deferred purchase requests (112) through public networks (104) into the deferred purchasing system (106). Embodiments of this kind include optional purchaser notifications (130) and optional payment information verifications (132). Embodiments of the kind illustrated in FIG. 1 are described in more detail below.

In embodiments of the kind shown in FIG. 1, public networks (104) include any kind of electronic communications network including internets and telecommunications networks, as described below in more detail. The execution environments of typical embodiments, such as, for example, SLEE and Parlay, are intended to operate across a variety of network platforms, including the Public Switched Telephone Network (PSTN), wireless networks, packet-based networks, LANs, WANs, internets, intranets, and so on. Communications protocols useful in various embodiments include the Internet Protocol (“IP”) and the Asynchronous Transfer Mode (“ATM”).

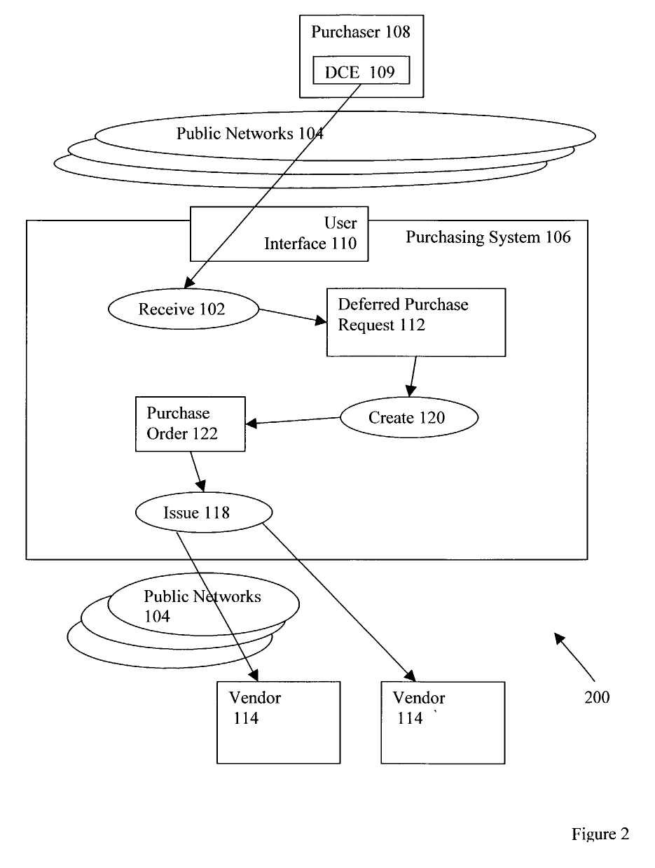

Turning now to FIG. 2, an exemplary embodiment (200) of the present invention is shown as a method for operating a publicly accessible deferred purchasing system. Embodiments of the kind shown in FIG. 2 include receiving (102) in a publicly accessible (104) deferred purchasing system (106), from a purchaser (108) through a user-interface (110), a deferred purchase request (“DPR”) (112).

In embodiments of the kind shown in FIG. 2, the purchaser utilizes data communication equipment (“DCE”)(109) for the user-interface (110) with the deferred purchasing system (106). DCE is any equipment capable of carrying out communication of information or data with a purchasing system. DCE can include, for example, a wired telephone, wireless telephone, personal digital assistants (“PDA”), computer systems, mobile computers, hand-held computers, laptop computers, network-enabled special purpose devices, and so on.

Within the Parlay OSA API is a generic user interface service capability feature. This generic user interface service capability feature is used by applications to interact with end-users. The generic user interface service capability feature includes a generic user interaction interface with methods to interact with an end-user. These methods include sending information to, or gathering information from the user, including users attached to a call. For call related purposes, a user interaction object is created. Information sent to the user includes announcements, menus, text, and data, the information being pre-defined or otherwise identified through Uniform Resource Locators (URLs) and the like. In collecting information from the end-user, a menu or announcement usually prompts for input such as a number of characters, including digits or text strings (such as “YES” if the end-user is using a telephone as the DCE (109)).

In a typical embodiment of the type shown in FIG. 2, receiving (102) a DPR (112) includes a purchaser's accessing the deferred purchasing system (106) by placing a telephone call to the deferred purchasing system. In this case, the public network (104) is a typical Public Switched Telephone Network (“PSTN”) and the purchaser's DCE (109) is a telephone handset. In response, a Parlay server establishes the call and creates a Parlay user interaction object for a user interaction with the purchaser. The user interaction object communicates an audible menu to the purchaser, the menu comprising prompts for a series of inputs from the purchaser's telephone keypad. The deferred purchasing system receives the inputs and stores the inputs as data in a DPR record.

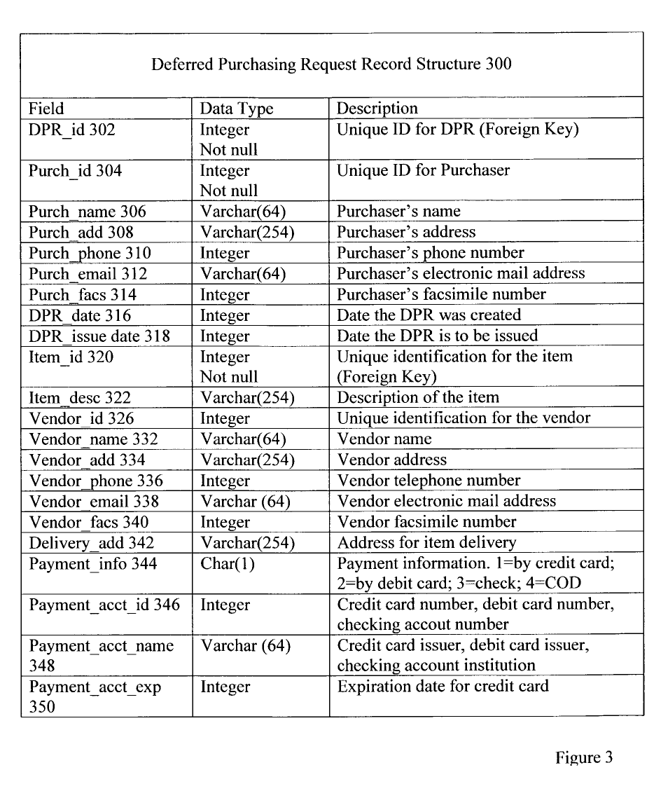

In such an embodiment, the audible menu prompt typically includes a request to input a unique user account number and personal identification number (“PIN”) using the telephone keypad, and both numbers must correspond to an authorized user account number and an authorized PIN. Once the authorization is established a subsequent audible prompt typically includes a message requesting the purchaser to input characters using the telephone keypad to describe the item to be purchased. In some embodiments, this item description input comprises a unique identification number (reference 320 on FIG. 3). The deferred purchasing system receives and stores the responsive identification number in the DPR record.

In other embodiments, the item description input includes telephone keypad responses to audible menu questions such as “Please choose from the following types of products: For clothing, press 1. For furniture, press 2. For photographic equipment, press 3.” Sub-menus are typically provided, as necessary, until the item is sufficiently described. For example, if the purchaser's response to the foregoing question was the keystroke “3,” the next menu typically includes a message such as “Please choose from the following types of photographic equipment: For digital cameras, press 1. For film cameras, press 2. For camcorders press 3.” As the purchaser inputs a numeric response to each question through the telephone keypad, the deferred purchasing system receives and records the characters in the DPR record.

In such embodiments, subsequent audible announcements prompt for a telephone keypad entry of an issue date (reference 318 on FIG. 3) by presenting an audible message to the purchaser such as: “Please enter the date on which you wish a purchase order to be issued for the item. Please enter four digits for the year, followed by two digits for the month, and two digits for the day of the month.” The deferred purchasing system receives (102) responsive input from the purchaser's telephone keypad and stores the input in the DPR record as the issue date.

In other typical embodiments of the type shown in FIG. 2, receiving (102) a DPR (112) includes a purchaser's accessing the deferred purchasing system (106) by placing a telephone call to the deferred purchasing system. In this case, the public network (104) is a typical Public Switched Telephone Network (“PSTN”) and the purchaser's DCE (109) is a telephone handset. In response, a Parlay server establishes the call and creates a Parlay user interaction object for a user interaction with the purchaser. The user interaction object communicates an audible menu to the purchaser, the menu comprising prompts for a series of inputs comprising spoken responses from the purchaser.

In such embodiments, wherein the input comprises spoken responses by the purchaser, the menu prompts for a spoken response from the purchaser and voice recognition software converts the purchaser's verbal response for storage in the DPR record. For example, the first audible menu prompt typically includes a message such as: “Please describe the item for which you want to place a deferred order.” As the purchaser responds, the verbal answer is converted to digital text. The next audible prompt typically reads back the digital text to the purchaser in a message such as: “You have ordered a Brand X Camcorder, Model XYZ. If this is correct, say Yes. If this is incorrect, say No.” A “No” response typically causes the original message requesting an item description to repeat. When a “Yes” response is received the deferred purchasing system is typically programmed to store the confirmed digital text in the DPR record as the item description (reference 322 on FIG. 3) or, optionally, the item identification (reference 320 on FIG. 3).

Similarly, embodiments of the kind shown in FIG. 2 that request a spoken response typically include an audible menu prompt with a message such as: “Please state the date on which you wish a purchase order to be issued for the item.” The voice recognition software then converts the verbal response from the purchaser to digital data in a date format and the deferred purchasing system stores the data in the DPR record as the issue date (reference 318 on FIG. 3).

In still other embodiments of the kind shown in FIG. 2, the deferred purchasing system (106) includes a web server with a conventional web site address that is publicly accessible by a purchaser (108). The purchaser's DCE (109) is a computer system having a web browser, monitor, mouse and keyboard. In these embodiments, the public network (104) is the internet, and receiving (102) the DPR (112) includes the purchaser's web browser creating a user-interface (110) with the deferred purchasing system web server when the purchaser enters the deferred purchasing system website address on the purchaser's computer keyboard. Once the web browser establishes the user-interface, the deferred purchasing system typically presents a visible message on the purchaser's monitor such as: “Please enter your user account number and password.” Following the purchaser's responsive entry of an authorized user account number and password, the deferred purchasing system typically presents item description menus on the purchaser's monitor to which the purchaser responds using the keyboard or a mouse. The deferred purchasing system receives (102) the purchaser's selection and records the purchaser's selection in the DPR record as the item description (reference 322 on FIG. 3) or, optionally, the item identification (reference 320 on FIG. 3).

In such embodiments, the deferred purchasing system typically presents another visible message on the purchaser's monitor such as: “Please enter the date on which you wish a purchase order to be issued for the item.” The purchaser again responds with input through the keyboard or mouse and the deferred purchasing system receives (102) the date and records the date in the DPR record (112) as the issue date (reference 318 on FIG. 3).

In additional embodiments of the kind shown in FIG. 2, the purchaser's DCE (109) is a hand-held computer including a micro-browser, screen display and keyboard. The deferred purchasing system (106) includes a Wireless Application Protocol (WAP) server accessible by the hand-held computer for the transmission and receipt of data through applications using the Internet Protocol (IP). In these embodiments, the public network (104) is a wireless network, and receiving (102) the DPR (112) includes the purchaser's micro-browser creating a user-interface (110) with the deferred purchasing system web server when the purchaser enters the deferred purchasing system website address on the purchaser's computer keyboard. Once the micro-browser establishes the user-interface, the deferred purchasing system typically presents a visible message on the purchaser's hand-held computer screen display such as: Please enter your user account number and password.” Following the purchaser's responsive entry of an authorized user account number and password, the deferred purchasing system typically presents item description menus on the purchaser's screen display and the purchaser inputs a response using the keyboard. The deferred purchasing system receives (102) the purchaser's inputted response and records the response in the DPR record as the item description (reference 320 on FIG. 3) or, optionally, as the item identification (reference 322 on FIG. 3).

In such embodiments wherein the purchaser's DCE (109) is a hand-held computer, the deferred purchasing system typically presents another visible message on the purchaser's screen display such as: “Please enter the date on which you wish a purchase order to be issued for the item.” The purchaser again inputs a response through the keyboard and the deferred purchasing system receives the date and records the date in the DPR record as the issue date (reference 318 on FIG. 3). In additional embodiments wherein the purchaser's DCE (109) is a hand-held computer, the purchaser inputs responses on the screen display using a stylus instead of a keyboard.

In still additional embodiments of the type shown in FIG. 2, the deferred purchasing system (106) includes a web server and the purchaser's DCE (109) includes a computer system having a web browser, monitor, keyboard, and mouse. The deferred purchasing system web server and the purchaser's computer system also include Voice over IP (VOIP) hardware and software. VOIP is a combination of hardware and software that provides a verbal conversation over the internet. In these embodiments the public network (104) is the internet, and receiving (102) the DPR (112) includes the purchaser's web browser creating a user-interface (110) with the deferred purchasing system web server when the purchaser enters the deferred purchasing system website address on the purchaser's computer keyboard. Once the web browser establishes the user-interface, the deferred purchasing system typically prompts the purchaser for a spoken item description while simultaneously providing visual product images on the purchaser's monitor.

For such embodiments, wherein VoIP is utilized, a typical verbal message would be: “Please state which of the displayed product categories you wish to review.” The purchaser's verbal response is received through VoIP and the deferred purchasing system is programmed to provide successive displays and accompanying verbal prompts until a sufficient item description has been verbally input by the purchaser. For example, the final product screen display and verbal prompt typically includes a display of several camcorder models offered by a manufacturer and a verbal prompt such as: “Please state the Brand X model you wish to purchase.” The purchaser's verbal response of “Model XYZ” completes the necessary item description input and the deferred purchasing system receives the data representing the purchaser's response and records the data in the DPR record as the item description (reference 322 on FIG. 3) or, optionally, the item identification (reference 320 on FIG. 3).

For the foregoing embodiments using VoIP, the deferred purchasing system also typically sends a verbal prompt for an issue date such as: “Please state the date on which you wish a purchase order to issue for the item.” The purchaser's verbal response is input and the deferred purchasing system receives the data representing the response and records the data in the DPR record as the issue date (reference 318 on FIG. 3).

For the kind of embodiments shown in FIG. 2, the DPR typically includes a DPR identification (reference 302 on FIG. 3), wherein the DPR identification is a unique identification for the DPR record that is created by the deferred purchasing system. The DPR also includes for such embodiments a purchaser identification (reference 304 on FIG. 3) and an item description of an item to be purchased (reference 322 on FIG. 3). The purchaser identification is a unique identification for the purchaser whose input created the DPR. In typical embodiments, this identification is the purchaser's previously established user account number.

In some embodiments of the kind illustrated in FIG. 2, the deferred purchasing system is controlled by a single vendor and all purchase orders issue to the controlling vendor. In other embodiments, wherein the deferred purchasing system is not so controlled, the purchaser inputs a vendor description, such as the vendor identification (reference 326 on FIG. 3), and the deferred purchasing system receives the vendor identification and records the description in the DPR record. Optionally, the purchaser inputs a vendor name (reference 332 on FIG. 3).

For example, in embodiments wherein the purchaser's DCE (109) is a telephone and a Parlay user interaction object has been created, the user interaction object typically prompts the purchaser for a telephone keypad inputted vendor identification number, by prompting with an audible menu prompt such as: “Please enter the three digit number for the vendor from which you would like to purchase the item.” The purchaser then enters the digits known by the purchaser to specify the vendor and the deferred purchasing system receives the inputted digits and stores the inputted digits in the DPR record as the vendor identification (reference 326 on FIG. 3).

Embodiments of the kind shown in FIG. 2 typically include creating (120) a purchase order (122) in dependence upon the DPR (112) and issuing the purchase order to a vendor (114) on the issue date. In these embodiments, creating a purchase order in dependence upon the DPR includes deriving data from a DPR record and incorporating the data into a purchase order. For example, data in the DPR record provides the identity of the vendor chosen by the purchaser (108) and the description of the item to be purchased. In some embodiments, vendor information needed to deliver the purchase order to the vendor is also derived from data in the DPR record, such as the vendor's name (reference 332 on FIG. 3), address (reference 334 on FIG. 3), telephone number (reference 336 on FIG. 3), electronic mail address (reference 338 on FIG. 3), or facsimile number (reference 340 on FIG. 3). In some embodiments, the purchaser inputs vendor information in response to prompts at the time the DPR is created. In other embodiments, this vendor information is stored in separate, pre-existing vendor records within the deferred purchasing system, the storage occurring prior to the creation of the DPR record. Further embodiments of the present invention are illustrated in which a DPR (112) optionally includes for the purchaser, a name (306), an address (308), a telephone number (310), an electronic mail address (312), a facsimile number (314), and a delivery address (342). In such embodiments, the subsequently issued purchase order (122) provides all or part of such information to the vendor (114) for the vendor's use in determining wherein to ship the item, soliciting additional information from the purchaser, entering the purchaser in a general customer database maintained by the vendor, and so on. In some embodiments, the purchaser name, address, telephone number, electronic mail address, facsimile number, and delivery address are stored in the DPR record from input received from the purchaser at the time the DPR is created. In other embodiments, the deferred purchase system loads such additional purchaser information into the DPR record from separate, pre-existing user account records.

For embodiments according to FIG. 2, wherein the purchase order (122) issues (118) to the vendor (114) by mail, creating (120) the purchaser order (122) includes merging item description data into a word processing file and printing the word processing file as a hardcopy document. In other embodiments, wherein the purchase order (122) issues (118) to the vendor (114) by electronic mail, creating (120) the purchase order typically includes merging the item description data into an electronic mail file and electronically mailing the electronic mail file to the vendor's electronic address using a deferred purchasing system mail server.

In other embodiments of the kind shown in FIG. 2, wherein the purchase order (122) is issued to the vendor (114) by facsimile, creating (120) the purchase order typically includes merging the item description data into an electronic facsimile file and sending the electronic facsimile file to the vendor facsimile number. In such embodiments, the only hardcopy purchase order produced is the hardcopy generated at the vendor's facsimile machine.

In still other embodiments of the kind shown in FIG. 2, wherein the purchase order (122) is issued (118) to the vendor (114) by telephone, creating the purchase order typically includes creating a recorded purchase order message that incorporates the item description data and purchaser information, such as the purchaser name (reference 306 on FIG. 3) and purchaser address (reference 308 on FIG. 3), from the DPR record. The deferred purchasing system then automatically calls the vendor using the vendor telephone number (reference 336 on FIG. 3) and delivers the message. In such embodiments, the vendor typically has voice recognition software for receiving audible telephone messages such as this one from the deferred purchasing system and converting the message to data usable by the vendor.

Embodiments of the type shown in FIG. 2 are shown in FIG. 3 to optionally include a DPR date (316) and a unique item identification (320). In typical embodiments, the deferred purchasing system stores the DPR date in the DPR record at the time of the record's creation. The date is useful for purposes such as establishing priority among purchaser's whose DPRs are for the same item and when the vendor has an inadequate number of the item in stock.

With regard to the optional unique item identification (320) depicted on FIG. 3, and in embodiments of the type shown in FIG. 2, the deferred purchasing system receives (102) this unique item identification from the purchaser in the form of a responsive input to a prompt at the time the DPR is created. The purchaser typically obtains such a number through sources including hardcopy catalogs, television advertisements, manufacturer websites, vendor websites, and so on.

Also shown on FIG. 3, for various embodiments according to FIG. 2, are fields for payment related information, including a payment information field (344) indicating the preferred method of payment, a payment account identification field (346), a payment account name field (348), and a payment account expiration date field (350). These embodiments include a Parlay-based menu prompt at the time the DPR is created, the prompt requesting the purchaser to enter input as to the preferred method of payment.

In such embodiments for example, when the purchaser (108) hears the preferred method of payment prompt, with its stated options, and then presses the “1” key on the purchaser's telephone keypad, the deferred purchasing system receives (102) the inputted character and records the inputted character in the DPR record. In this case, this input or an input of the numbers “2” or “3” causes an additional prompt for the identification of the account associated with the manner of payment selected. In such embodiments this includes a credit card number, a debit card number, or a checking account number. The menu also prompts the purchaser in such a case for input as to the name (348) and expiration date (350) of the credit card identified. Later, the deferred purchasing system typically reads the “Payment_info” field as an indication that the purchaser desires to pay by credit card when the inputted number is “1,” by debit card if the number is “2,” and by check if the number is “3.” The deferred purchasing system records the account number in the “Payment_acct_id” field, the card number in the “Payment_acct_name” field, and the expiration date in the “Payment_acct_exp” field. The account number, card number, and expiration date are useful for the vendor's billing needs, and for payment verification purposes discussed below.

Similarly, in those embodiments according to FIG. 2, wherein the Parlay user interaction object supports voice recognition, the deferred purchasing system is typically programmed to send an audible message such as: “Please state your intended method of payment from among the following choices: credit card, debit card, check, or COD.” If the purchaser responds by verbally inputting the words: “Credit card,” the next audible message typically presented to the purchaser is: “Please state the name of the credit card issuer.” When the purchaser has verbally responded with the requested name, the next audible message is typically: “Please state the account number on your credit card.” After the purchaser verbally responds with the credit card number, the next audible message is typically: “Please state the expiration date shown on your credit card.”

Furthermore, as the verbal responses indicating the credit card preference, the credit card issuer name, the credit card number and the credit card expiration date, are inputted, the deferred purchasing system is typically programmed to construct one or more messages from the data resulting from the conversion of these purchaser verbal responses, and send the constructed message to the purchaser with an audible request for confirmation. Following the receipt of a confirming verbal response from the purchaser, the deferred purchasing system stores the data resulting from the conversions of the purchaser's verbal responses in the DPR record.

It should be noted that, for the deferred purchasing system (106) according to embodiments of the present invention, there is no strict requirement that the issue date must be entered at the moment the DPR is created. Alternately, for example, the purchaser (108) specifies a delivery date and the deferred purchasing system is programmed to automatically provide an issue date sufficiently in advance to give the vendor time to meet the delivery date. Alternately, for example, the deferred purchasing system is programmed to prompt the purchaser for an issue date at some point in time after the DPR is created.

The following DDL script is an example of a script useful within the present invention to create a table for aggregating DPR records (300) based upon the DPR described above and illustrated in FIG. 3.

create table DPR (

| | |
|---|---|
| DPR_id | integer not null, |
| Purch_id | integer not null, |
| Purch_name | varchar(64), |
| Purch_add | varchar(254), |
| Purch_phone | integer, |
| Purch_email | varchar(64), |
| Purch_facs | integer, |
| DPR_date | integer, |
| DPR_issue | integer, |
| Item_id | integer, |
| Item_desc | varchar(254), |
| Vendor_id | integer, |
| Vendor_name | integer, |
| Vendor_address varchar(254), | |
| Vendor_phone | integer, |
| Vendor_email | varchar(64), |
| Vendor_facs | integer, |
| Deliver_add | varchar(254) |
| Payment_info | char( 1) |
| Payment_acct_id | integer |
| Payment_acct_name | varchar(64) |
| Payment_acct_exp | integer |

);

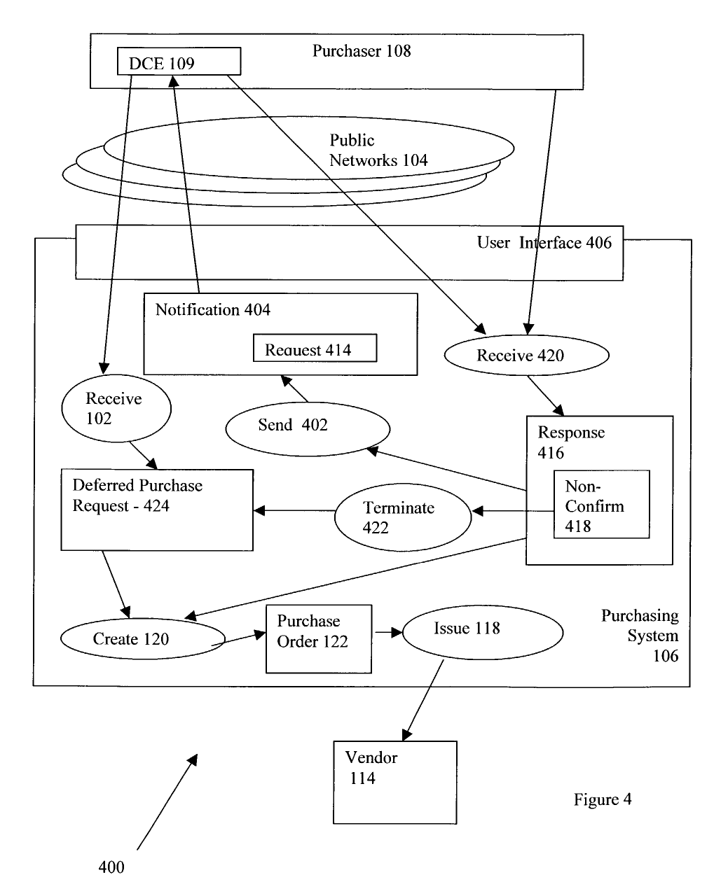

Turning now to FIG. 4, additional exemplary embodiments are shown that include sending (402) a notification (404) to the purchaser (108) prior to the issue date. In the embodiment shown, the deferred purchasing system is typically programmed to assign a date for the sending that is prior to the issue date. In some such embodiments the purchaser inputs the date in response to a prompt at the time the DPR is created. In other embodiments, the deferred purchasing system automatically assigns this date based on a previously determined number of days before the issue date.

On the notification date in such embodiments, the deferred purchasing system (106) sends (402) the notification (404) to the purchaser (108), the notification including the issue date and the item description. Purchaser information in the DPR (424) such as the purchaser's electronic mail address (reference 312 on FIG. 3) and the like, allow the notification to be sent using various channels of communication.

In some embodiments of the kind shown in FIG. 4, the deferred purchasing system (106) does not solicit a response from the purchaser to the notification. In other embodiments, the notification optionally includes a request (414) to the purchaser (108) for a pre-issue date confirmation response (416). In these types of embodiments it is typical for the deferred purchasing system to utilize a Parlay-based telephone call, including a user interaction object, to send (402) the notification. In this case, the public network (104) is a typical Public Switched Telephone Network (“PSTN”) and the purchaser's DCE (109) is a telephone handset. In this regard, the user interaction object communicates an announcement containing the notification to the purchaser. The announcement is derived from data read from the DPR record, such as the item description data and the issue date data.

In such embodiments, wherein the announcement containing the notification (404) with request (414) for confirmation is communicated by the user interaction object, the communicated announcement typically includes a subsequent menu prompt for telephone keypad input from the purchaser confirming or rejecting the deferred purchase described in the notification announcement. A typical prompt for confirmation in this regard is: “Do you still wish to purchase the item described? If so, press 1. If you wish to terminate the order, press 2.”

In such an embodiment, if a non-confirming response (418) is received (420) in response to the prompted request (414) for confirmation, the deferred purchasing system is typically programmed to terminate (422) the DPR (424). The deferred purchasing system is programmed to treat as a non-confirming response the purchaser's responsive input of “2,” or any failure to input “1,” including hang-ups or the pressing of any key other than “1.” In such embodiments, the deferred purchasing system terminates (422) the DPR (424) if no confirming response is received (420), and no purchase order will issue. Conversely, if a confirming response (416) is received (420) the scheduled issue date for the purchase order remains in effect.

For embodiments according to FIG. 4, wherein the notification (404) with request (414) for confirmation is sent (402) to the purchaser by mail, the deferred purchasing system (106) typically merges the item description data and issue date data into a word processing file and prints the word processing file as a hardcopy document for mailing to the purchaser. The word processing file typically includes as part of the notification (404) for confirmation a message that reads: “This message concerns your deferred purchase order, #123456, for a Brand X camcorder, Model XYZ, for which a purchase order is scheduled to issue on Jan. 1, 2003. This message is a request for confirmation of your continued interest in the purchase. Please call 111-111-1111 and confirm your continued interest on or before Dec. 1, 2002. Without such confirmation the deferred purchase order will terminate on Dec. 2, 2002.”

After receipt of such notification by mail the purchaser must provide a confirming response (416), the deferred purchasing system typically receiving (420) the response (416) through various methods. For example, the example notification contains a special confirmation telephone number for the purchaser's use. When the call is made by the purchaser to the special number, a Parlay-based user interaction object is typically created that communicates a series of messages to the purchaser that first request authorization input and, in subsequent messages request DPR identification input, and then confirmation input. Typical messages in this regard include:

“Please enter your user account number and PIN.”

“Please enter the DPR identification number.”

“Please press 1 to confirm your continued wish to purchase the item. Please press 2 to terminate the purchase.”

In other embodiments, wherein the notification (404) with request (414) for confirmation is sent (402) to the purchaser by electronic mail, the deferred purchasing system typically merges the item description data and issue date data into an electronic mail file and electronically mails the electronic mail file to the purchaser's electronic mail address using a deferred purchasing system mail server. In such a case, the electronic mail file will also include a request an electronic mail reply to indicate confirmation of the DPR.

In other embodiments of the kind shown in FIG. 4, wherein the notification (404) with request (414) for confirmation is sent (402) to the purchaser by facsimile, the deferred purchasing system merges the item description data and issue date data into an electronic facsimile file and sends (402) the electronic facsimile file to the purchaser's facsimile number. In these embodiments, the public network (104) is a typical Public Switched Telephone Network (“PSTN”) and the purchaser's DCE (109) is a facsimile machine. In such embodiments, the only hardcopy of the notification with request produced is the hardcopy generated at the purchaser's facsimile machine. The facsimile typically has the special confirmation telephone number discussed above with respect for confirmation to the embodiments wherein the notification with request is mailed in hardcopy form.

In other embodiments of the kind illustrated in FIG. 4, the notification (404) includes the DPR identification number (reference 302 on FIG. 3). The DPR identification number is useful for referencing by the purchaser (108) in the event the purchaser chooses a traditional form of response such as a personal telephone call or a letter.

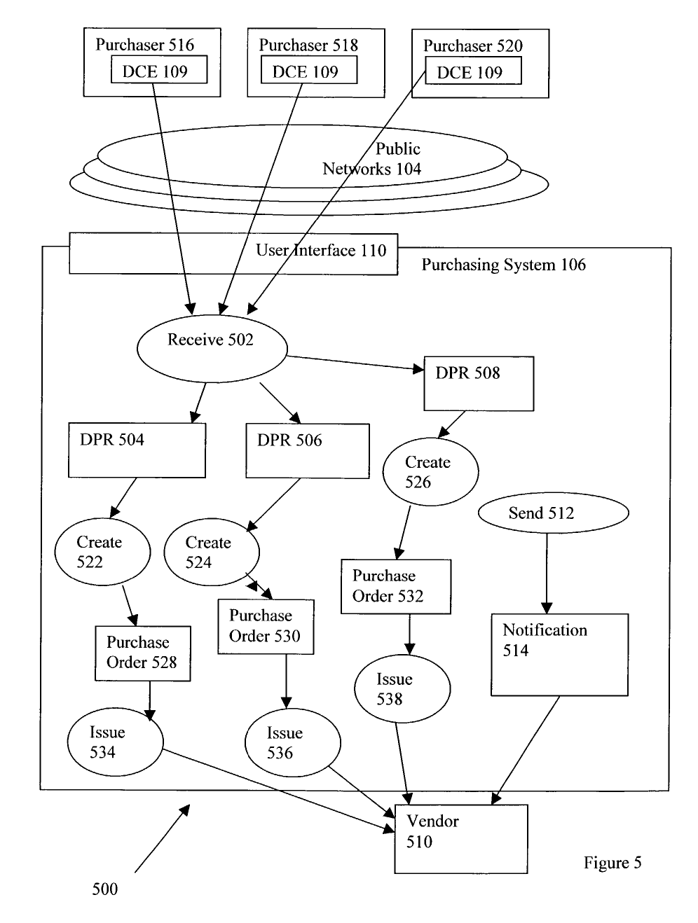

Turning now to FIG. 5, additional exemplary embodiments are illustrated wherein receiving a DPR further includes receiving (502) a plurality of DPRs (504, 506, 508) from one or more purchasers (516,518,520) for the same item to be purchased from the same identified vendor (510). As records for all such DPRs are created, they are each registered in a table, and the deferred purchasing system is typically programmed to find all DPR records for the same item and same vendor, either periodically or optionally as each DPR record is added to the table.

In such embodiments, and when at least two DPRs for the same item and vendor are so found, the deferred purchasing system sends (512) a notification (514) to the vendor (510), the notification including the issue dates, identifications of the DPRs in the plurality, and an identification of the item, which typically comprises the item identification (reference 320 on FIG. 3) or the item description (reference 322 on FIG. 3). In these embodiments, such a notification provides the vendor with adequate time in which to ensure the availability of a sufficient quantity of the item to honor all the subsequently created (522,524,526) purchase orders (528,530,532) at the time each purchase order issues (534,536,538).

For embodiments of the kind shown in FIG. 5, wherein the notification (514) is sent (512) to the vendor (510) by telephone, the deferred purchasing system typically utilizes a Parlay-based telephone call, including a user interaction object, to send (512) the notification. In such embodiments, the public network (104) is a typical Public Switched Telephone Network (“PSTN”) and the purchaser's DCE (109) is a telephone handset. In these embodiments the user interaction object communicates an announcement containing the notification to the vendor. The announcement is derived from data read from the DPR record, such as item description data, issue date data, and DPR identification data. In such embodiments, the vendor typically has voice recognition software for receiving audible telephone messages such as this one from the deferred purchasing system and then converting the message to data usable by the vendor. In such embodiments, the notification announcement typically states: “Please be aware that the following deferred purchase orders are for the purchase of a Brand X camcorder, Model XYZ, and will issue to your company on the date indicated. The deferred purchase orders are DPR No. 123456 issuing on January 1, 2003, DPR No. 654321 issuing on Jan. 5, 2003, DPR No. 123654 issuing on Jan. 8, 2003”

In other embodiments according to FIG. 5, wherein the notification (514) is sent (512) to the vendor (510) by mail, the deferred purchasing system (106) merges the data representing the issue dates, the identifications of DPRs in the plurality, and the item identifications into a word processing file and prints the file as a hardcopy document. In other embodiments, wherein the notification (514) is sent (512) to the vendor (510) by electronic mail, the deferred purchasing system (106) typically merges the data representing the issue dates, the identifications of the DPRs in the plurality, and the item identifications into an electronic mail file and electronically mails the electronic mail file to the vendor's electronic mail address using a deferred purchasing system mail server.

In still other embodiments of the kind shown in FIG. 5, wherein the notification (514) is sent (512) to the vendor (510) by facsimile, the deferred purchasing system merges the data representing the issue dates, the identifications of the DPRs in the plurality, and the item identifications into an electronic facsimile file, and sends the electronic facsimile file to the vendor facsimile number. In these embodiments, the public network (104) is a typical Public Switched Telephone Network (“TSTN”) and the purchaser's DCE (109) is a facsimile machine. In such embodiments, the only hardcopy notification produced is the hardcopy generated at the vendor's facsimile machine.

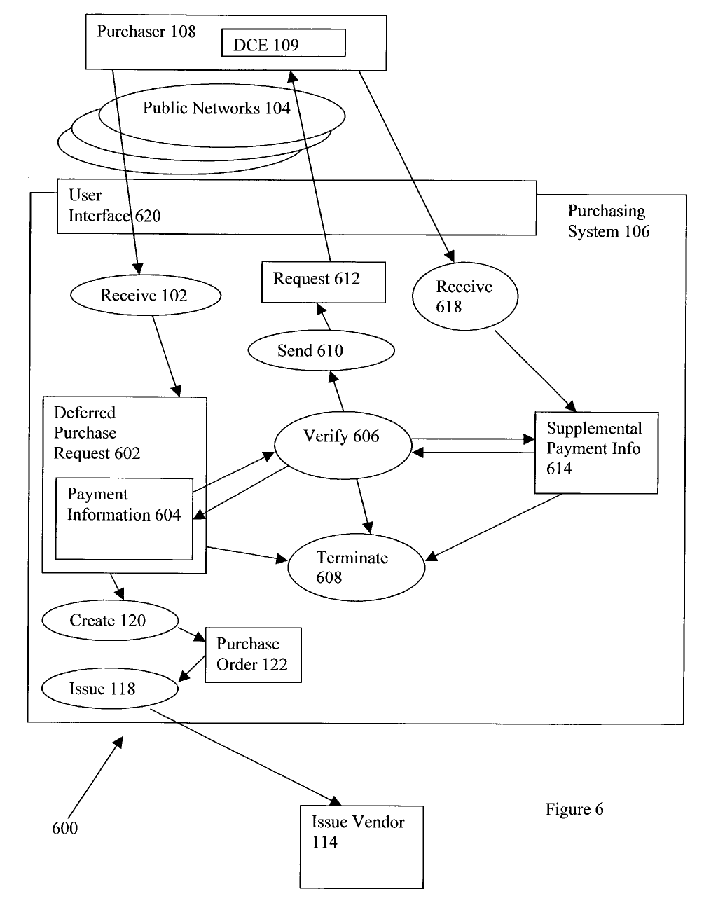

Turning now to FIG. 6, additional embodiments are shown wherein the DPR (602) includes payment information (604). Such embodiments include verifying (606) the payment information prior to the issue date, and the deferred purchasing system (106) is typically programmed to automatically assign a date for the verification based on a previously determined number of days before the issue date.

In embodiments according to FIG. 6, and at the time of the assigned verification date, the deferred purchasing system verifies (606) the payment information (604) by establishing that credit card, debit card, or checking account previously received (102) from the purchaser is a then current and valid payment method. For example, if the purchaser originally responded to a Parlay user interaction object menu prompt by inputting a “1,” the deferred purchasing system receives (102) the input and records the input in a “Payment_Info” field of the DPR record. In such an example, the deferred purchasing system interprets this character on the date of verification as an intent to pay by credit card. In such an example, the credit card number was also originally input by the purchaser for recording by the deferred purchasing system in a “Payment_Acct_Id” field of the DPR record, along with a credit card name in a “Payment_acct_name” field, and a credit card expiration date in a “Payment_acct_exp” field. In such a case verifying (606) the payment information (604) includes authorizing a charge against the credit card from a credit authorization agency, using the credit card number, name and expiration date.

Embodiments of the kind illustrated in FIG. 6 typically include terminating (608) the DPR (602) if the payment information (604) verification is unsatisfactory. Unsatisfactory payment information verification in such an example includes the rejection of the charge by the authorization agency.

Embodiments of the kind shown in FIG. 6 also typically include, when the verification is unsatisfactory, sending (610) a request (612) for supplemental payment information (614) from the purchaser (108). For embodiments according to FIG. 6, wherein the request is sent to the purchaser by mail, the deferred purchasing system merges the item description data and issue date data into a word processing file and print the word processing file as a hardcopy document for mailing to the purchaser. The request typically reads: “This message concerns your deferred purchase order, #123456, for a Brand X camcorder, Model XYZ, for which a purchase order was originally scheduled to issue on January, 2003. The payment information you originally provided is no longer satisfactory. Please call 999-999-9999 and provide new payment information on or before Dec. 1, 2002. Without additional payment information the deferred purchase order will terminate on Dec. 2, 2002.”

In such embodiments, when a call is made by the purchaser to the special number, a Parlay-based user interaction object is typically created that communicates a series of messages to the purchaser that first requests authorization input and, in subsequent messages requests DPR identification input, and then supplemental payment information input. Typical messages in this regard include:

“Please enter your user account number and PIN.”

“Please enter the DPR identification number.”

“Please enter your new intended method of payment from among the following choices: For a credit card, press 1. For a debit card, press 2, for a check, press 3, for COD, press 4”

“Please enter the name of the credit card issuer, using the letters represented by numbers on your telephone keypad.”

“Please enter the account number on your credit card.”

“Please enter the expiration date shown on your credit card.”

The deferred purchasing system receives (618) and stores the purchaser's inputted supplemental payment information (606) in the DPR record, replacing the unverifiable payment related information.

In other embodiments, wherein the request (612) for supplemental payment information (614) is sent (610) to the purchaser (108) by electronic mail, the deferred purchasing system, typically merges the item description data and issue date data into an electronic mail file and electronically mails the electronic mail file to the purchaser's electronic mail address using a deferred purchasing system mail server. In such embodiments, the electronic mail file additionally requests an electronic mail reply providing the supplemental payment information. Upon receipt (618) of the reply, the deferred purchasing system typically reads from the electronic mail reply the supplemental payment information (614) and stores the supplemental payment information in the DPR record.

In other embodiments of the kind shown in FIG. 6, wherein the request (612) for supplemental payment information (614) is sent (610) to the purchaser by facsimile, the deferred purchasing system typically merges the item description data into an electronic facsimile file and sends the electronic facsimile file to the purchaser's facsimile number. In these embodiments, the public network (104) is a typical Public Switched Telephone Network (“TSTN”) and the purchaser's DCE (109) is a facsimile machine. In such embodiments, the only hardcopy request produced is the hardcopy generated at the purchaser's facsimile machine. The facsimile has the special supplemental payment information telephone number discussed above with respect to the embodiments wherein the request for supplemental payment information is mailed in hardcopy form.

In still other embodiments of the kind shown in FIG. 6, wherein the request (612) for supplemental payment information (614) is sent (610) to the purchaser by telephone, it is typical for the deferred purchasing system to utilize a Parlay-based telephone call, including a user interaction object, to send (610) the request (612). In these embodiments, the public network (104) is a typical Public Switched Telephone Network (“PSTN”) and the purchaser's DCE (109) is a telephone handset. In this regard, the user interaction object communicates an announcement containing the request to the purchaser. The announcement is derived from data read from the DPR record, such as the item description data and the issue date data. In such embodiments, the purchaser listens to the message personally and the announcement requests the purchaser to provide supplemental payment information during the telephone call. Typical messages in this regard include:

“This message concerns your deferred purchase order, numbered 123456, for a Brand X camcorder, Model XYZ, for which a purchase order was originally scheduled to issue on January, 2003. The payment information you originally provided is no longer satisfactory. Unless additional payment information is provided during this call, the deferred purchase order will terminate on Dec. 2, 2002.”

“In this regard, please enter your new intended method of payment from among the following choices: For a credit card, press 1. For a debit card, press 2, for a check, press 3, for COD, press 4”

“Please enter the name of the credit card issuer, using the letters represented by numbers on your telephone keypad.”

“Please enter the account number on your credit card.”

“Please enter the expiration date shown on your credit card.”

The deferred purchasing system receives (618) the purchaser's inputted supplemental payment information (606) and stores the supplemental payment information in the DPR record, replacing the unverifiable payment related information.

In the embodiments wherein the purchaser (108) provides supplemental payment information (614), the purchaser's input is stored in the DPR record (602). With the supplemental payment information recorded in the DPR, the deferred purchasing system in such examples verifies (606) the supplemental payment information. If the purchaser fails to provide supplemental payment information, or provides unverifiable supplemental payment information, the DPR is terminated (608)

It is to be noted that, in various embodiments, the item to be purchased is a tangible good, while in others the item to be purchased is a service or a software license. Embodiments of the types shown in FIGS. 1-6 typically provide all such items.

Although the embodiments of the present invention have been described to a large extent using Parlay for telephonic user interactions with the deferred purchasing system, persons skilled in the art will recognize that such embodiments are suitably utilized in a SLEE environment as well. Both JAIN API in a SLEE environment, and the Parlay OSA API, establish a user-interface for a purchaser that provides the interaction necessary to present a variety of optional purchasing strategies to the purchaser, while prompting audibly or visibly as needed to acquire input from the purchaser. The input from the purchaser provides the data needed to create the record containing the DPR, the DPR record then being available for use with regard to payment information verification, pre-issue notifications to vendors and purchasers, and other features shown to be provided in the various embodiments of the invention.

By this point in our discussion readers clearly understand the benefits to business organizations in using various embodiments of the present invention. In particular, delayed purchase requests are supplied from a provider, such as a telephone company or an internet service provider, to any company or organization that provides telephone ordering, thereby allowing a delayed purchasing service provide cross-enterprise inventory purchasing and other supply chain functions, while providing a valued service to subscribers or providers' services generally.

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method for operating a publicly accessible purchasing system, the method comprising:
receiving from a purchaser in a publicly accessible purchasing system, a deferred purchase request (“DPR”), wherein the DPR comprises an item description for an item to be purchased and an issue date when a purchase order is to be issued to a vendor;
creating the purchase order in dependence upon the DPR; and
issuing the purchase order to the vendor on the issue date.

2. The method of claim 1 wherein the DPR further comprises a vendor description for the vendor to which the purchase order is to be issued.

3. The method of claim 1, further comprising sending a notification to the purchaser prior to the issue date, the notification comprising the issue date and the item description.

4. The method of claim 3 wherein the notification further comprises a request for a pre-issue date confirmation response by the purchaser.

5. The method of claim 4 wherein no confirming response is received and the method further comprises terminating the DPR.

6. The method of claim 1 wherein receiving a DPR further comprises receiving a plurality of DPRs for the same item to be purchased from the same vendor, and the method further comprises sending a notification to the vendor, the notification comprising the issue dates, an identification of the item and the identification of DPRs in the plurality.

7. The method of claim 1 wherein the DPR includes payment information, the method further comprising verifying the payment information prior to the issue date.

8. The method of claim 7 further comprising terminating the DPR if the payment information verification is unsatisfactory.

9. The method of claim 7 wherein the verification is unsatisfactory and the verifying further comprises sending a request for supplemental payment information to the purchaser.

10. The method of claim 9 wherein no verifiable supplemental payment information is received and the method further comprises terminating the DPR.

11. A method for operating a publicly accessible purchasing system, the method comprising:
receiving from a purchaser in a publicly accessible purchasing system, a deferred purchase request (“DPR”), wherein the DPR comprises an item description for an item to be purchased;
creating a purchase order in dependence upon the DPR; and
issuing the purchase order to a vendor on a date subsequent to the date the DPR is created.

12. The method of claim 11 wherein the DPR further comprises an issue date and issuing the purchase order to the vendor further comprises issuing the purchase order to the vendor on the issue date, the method further comprising determining the issue date on the basis of a delivery date specified by the purchaser.

13. The method of claim 11 wherein the DPR further comprises an issue date and issuing the purchase order to the vendor further comprises issuing the purchase order to the vendor on the issue date, the method further comprising prompting the purchaser for the issue date and receiving the issue date from the purchaser.

14. A system for operating a publicly accessible purchasing system, the system comprising:
means for receiving from a purchaser in a publicly accessible purchasing system, a deferred purchase request (“DPR”), wherein the DPR comprises an item description for an item to be purchased and an issue date when a purchase order is to be issued to a vendor;
means for creating the purchase order in dependence upon the DPR; and
means for issuing the purchase order to the vendor on the issue date.

15. The system of claim 14 wherein the DPR further comprises a vendor description for the vendor to which the purchase order is to be issued.

16. The system of claim 14, further comprising means for sending a notification to the purchaser prior to the issue date, the notification comprising the issue date and the item description.

17. The system of claim 16 wherein the notification further comprises a request for a pre-issue date confirmation response by the purchaser.

18. The system of claim 17 wherein no confirming response is received and the system further comprises means for terminating the DPR.

19. The system of claim 14 wherein means for receiving a DPR further comprises means for receiving a plurality of DPRs for the same item to be purchased from the same vendor, and the system further comprises means for sending a notification to the vendor, the notification comprising the issue dates, an identification of the item and the identification of DPRs in the plurality.

20. The system of claim 14 wherein the DPR includes payment information, the system further comprising means for verifying the payment information prior to the issue date.

21. The system of claim 20 further comprising means for terminating the DPR if the payment information verification is unsatisfactory.

22. The system of claim 20 wherein the verification is unsatisfactory and the verifying further comprises means for sending a request for supplemental payment information to the purchaser.

23. The system of claim 22 wherein no verifiable supplemental payment information is received and the system further comprises means for terminating the DPR.

24. A system for operating a publicly accessible purchasing system, the system comprising:
means for receiving from a purchaser in a publicly accessible purchasing system, a deferred purchase request (“DPR”), wherein the DPR comprises an item description for an item to be purchased;
means for creating a purchase order in dependence upon the DPR; and
means for issuing the purchase order to a vendor on a date subsequent to the date the DPR is created.

25. The system of claim 24 wherein the DPR further comprises an issue date and issuing the purchase order to the vendor further comprises means for issuing the purchase order to the vendor on the issue date, the system further comprising means for determining the issue date on the basis of a delivery date specified by the purchaser.

26. The system of claim 24 wherein the DPR further comprises an issue date and issuing the purchase order to the vendor further comprises means for issuing the purchase order to the vendor on the issue date, the system further comprising means for prompting the purchaser for the issue date and receiving the issue date from the purchaser.

27. A computer program product for operating a publicly accessible purchasing system, the computer program product comprising:
a recording medium;
means, recorded on the recording medium, for receiving from a purchaser in a publicly accessible purchasing system, a deferred purchase request (“DPR”), wherein the DPR comprises an item description for an item to be purchased and an issue date when a purchase order is to be issued to a vendor;
means, recorded on the recording medium, for creating the purchase order in dependence upon the DPR; and
means, recorded on the recording medium, for issuing the purchase order to the vendor on the issue date.

28. The computer program product of claim 27 wherein the DPR further comprises a vendor description for the vendor to which the purchase order is to be issued.

29. The computer program product of claim 27, further comprising means, recorded on the recording medium, for sending a notification to the purchaser prior to the issue date, the notification comprising the issue date and the item description.

30. The computer program product of claim 29 wherein the notification further comprises a request for a pre-issue date confirmation response by the purchaser.

31. The computer program product of claim 30 wherein no confirming response is received and the computer program product further comprises means, recorded on the recording medium, for terminating the DPR.

32. The computer program product of claim 27 wherein means, recorded on the recording medium, for receiving a DPR further comprises means, recorded on the recording medium, for receiving a plurality of DPRs for the same item to be purchased from the same vendor, and the computer program product further comprises means, recorded on the recording medium, for sending a notification to the vendor, the notification comprising the issue dates, an identification of the item and the identification of DPRs in the plurality.

33. The computer program product of claim 27 wherein the DPR includes payment information, the computer program product further comprising means, recorded on the recording medium, for verifying the payment information prior to the issue date.

34. The computer program product of claim 33 further comprising means, recorded on the recording medium, for terminating the DPR if the payment information verification is unsatisfactory.

35. The computer program product of claim 33 wherein the verification is unsatisfactory and the verifying further comprises means, recorded on the recording medium, for sending a request for supplemental payment information to the purchaser.

36. The computer program product of claim 35 wherein no verifiable supplemental payment information is received and the computer program product further comprises means, recorded on the recording medium, for terminating the DPR.

37. A computer program product for operating a publicly accessible purchasing system, the computer program product comprising:
a recording medium;
means, recorded on the recording medium, for receiving from a purchaser in a publicly accessible purchasing system, a deferred purchase request (“DPR”), wherein the DPR comprises an item description for an item to be purchased;
means, recorded on the recording medium, for creating a purchase order in dependence upon the DPR; and
means, recorded on the recording medium, for issuing the purchase order to a vendor on a date subsequent to the date the DPR is created.

38. The computer program product of claim 37 wherein the DPR further comprises an issue date and issuing the purchase order to the vendor further comprises means, recorded on the recording medium, for issuing the purchase order to the vendor on the issue date, the computer program product further comprising means, recorded on the recording medium, for determining the issue date on the basis of a delivery date specified by the purchaser.

39. The computer program product of claim 37 wherein the DPR further comprises an issue date and issuing the purchase order to the vendor further comprises means, recorded on the recording medium, for issuing the purchase order to the vendor on the issue date, the computer program product further comprising means, recorded on the recording medium, for prompting the purchaser for the issue date and receiving the issue date from the purchaser.
